(19) United States
(12) Patent Application Publication
(10) Pub. No.: US 2026/0241913 A1
(43) Pub. Date: Aug. 20, 2026

(54) ELECTRO-ACTUATED DISC BRAKE CALIPER, DISC BRAKE AND BRAKING SYSTEM

(71) Applicant: BREMBO S.p.A., Curno (Bergamo) (IT)

(72) Inventors: Mauro MAMBRETTI, Curno (Bergamo) (IT); Cristian CRIPPA, Curno (Bergamo) (IT)

(73) Assignee: BREMBO S.p.A., Curno (Bergamo) (IT)

(21) Appl. No.: 19/472,415

(22) PCT Filed: Apr. 4, 2024
(86) PCT No.: PCT/IB2024/053278

§ 371 Date: Oct. 3, 2025

(30) Foreign Application Priority Data
Apr. 7, 2023 (IT) 102023000006918

(51) Int. Cl. B60T 13/74; B60T 13/58; F16D 55/00; F16D 55/228; F16D 65/00; F16D 65/18; F16D 121/04; F16D 121/24; F16D 125/40; F16D 125/52

(52) U.S. Cl. CPC B60T 13/746; B60T 13/588; F16D 55/228; F16D 65/0068; F16D 65/18; F16D 65/183; F16D 2055/0016; F16D 2055/0091; F16D 2121/04; F16D 2121/24; F16D 2125/40; F16D 2125/52

(57) ABSTRACT

An electro-actuated disc brake caliper has a caliper body adapted to straddle a brake disc provided with a first braking surface and an opposite second braking surface, the caliper body having a first elongated element facing the first braking surface, a second elongated element facing the second braking surface, and at least one connecting bridge joining the first elongated element to the second elongated element passing over the brake disc. At least one of the first and second elongated elements has at least one thrust seat for accommodating thrust means having at least one mechanical movement device adapted to be operated by an electric motor for sliding a thrust device in the at least one thrust seat to abut against a brake pad, and at least one additional second motor seat accommodating the electric motor for a controlled operation of the at least one mechanical movement device.

### FIELD OF THE INVENTION

The present invention relates to an electro-actuated disc brake caliper.

In addition, the present invention relates to a disc brake comprising said caliper and to a braking system comprising said disc brake.

### BACKGROUND ART

In a disc brake, the brake caliper is generally arranged straddling the external peripheral margin of a brake disc, adapted to rotate about a rotation axis (X-X) defining an axial direction (A-A). In a brake disc, there are also defined a radial direction (R-R) substantially orthogonal to said axial direction (A-A), a circumferential direction (C-C) orthogonal to both said axial direction (A-A) and said radial direction (R-R), and a tangential direction (T-T) locally, or rather punctually, i.e., in an intersection point of an axial and a radial direction, orthogonal to both said axial direction (A-A) and said a radial direction (R-R).

As known, the disc brake caliper is exposed to impacts from objects that, by entering the wheel rim, are confined by the latter and sometimes driven into rotation, risking collisions with the brake disc and especially with the disc brake caliper which, being stationary with respect to the vehicle, because it is constrained to the stub axle of the suspension, ends up having a higher relative velocity than these objects.

It is also known to manufacture electro-actuated disc brake calipers. In these solutions, this problem is even more significant because the motor components are placed cantilevered over the caliper body and thus more exposed to accidental impacts from objects entering the wheel rim while the vehicle is moving.

For example, document WO2021019380A1 shows an electro-actuated caliper in which the electric motor (here indicated by reference numeral 15) is placed cantilevered above an elongated element of the caliper body and is fully exposed to accidental impacts. A similar solution is disclosed in US2015354645A1, US2020256411A1. For example, document U.S. Pat. No. 9,989,114B2 shows an electro-actuated caliper, in which the electric motor, here indicated by reference numeral 50, is accommodated in a support, referred to as a gearmotor unit, which is clearly a separate element coupled to the caliper body. This solution is highly bulky in the axial direction because it axially adds an element to the axial extension of the caliper body. In addition, the coupling between the separate gearmotor unit and the actuator of the brake pads (reference numerals 42 and 40) by means of a connection, threaded here, creates major doubts about the proper operation over time, considering that the brake caliper is an unsprung mass of the vehicle and undergoes strong or very strong accelerations, and thus stresses, which could loosen the connection or separate the gearmotor unit 50 from the caliper body.

Solutions are also known, such as US2007227838A1 or EP1590578A1 or WO0060255A1 or US2006267402 or US2018148030A1 or US2019003535A1 or U.S. Pat. No. 6,030,054A or US2019120311A1, where, having a floating caliper, but sometimes even in fixed caliper solutions, the electric motor (or electric motors) is/are placed parallel to the brake disc axis and is/are partially accommodated within the floating (or fixed) part of the caliper, much of which protrudes therefrom cantilevered outward in the axial direction, thus moving away by a considerable extent from the caliper body, thus obliging to construct special external fairings which, in any case, are in turn more exposed to impacts, especially in this case, where they extend considerably cantilevered in the direction parallel to the rotation axis of the brake disc (see for example reference numeral 10 in US2007227838A1, or reference numeral 38 in EP1590578A1 or reference numeral 1 in WO0060255A1, or reference numeral 20 in US2006267402, as well as reference numeral 160 in US2018148030A1, or reference numerals 4 and 6 in US2019003535A1, as well as reference numeral 4 in U.S. Pat. No. 6,030,054A and reference numerals 72 and 40 in US2019120311A1).

Additionally, the presence of electric motors and gear units thereof, in many of these solutions working in parallel on the thrust devices to apply a braking action often for parking-, creates meander in these complex assemblies from which are difficult to clean from possible gas bubbles formed when the brake fluid is changed.

Thus, the need is particularly felt to rationalize the arrangement of the gearmotor in order to simplify, sometimes to allow, proper cleaning of the hydraulic system of the disc brake caliper.

Indeed, it is known that if gas bubbles, being compressible and more subject to volume change in case of temperature increases, remain in the brake fluid, they could lead to serious malfunctions of the braking system and even to the inability of transmitting through the brake fluid the desired braking command to the thrust means and thus resulting in an incorrect or even absent braking action of the vehicle.

### Solution

It is an object of the present invention to provide an electro-actuated disc brake caliper as well as a disc brake comprising said caliper and a braking system comprising said disc brake.

This and other objects and advantages are achieved by an electro-actuated brake caliper according to claim 1.

Some advantageous embodiments are the subject of the dependent claims.

By virtue of the suggested solutions, it is possible to have the electric motors or gearmotors directly inside the caliper body, without any “visible” parts, helping to increase the protection of the components from foreign bodies which could come into contact by entering the wheel side of the car, generating issues related to safety and resistance.

The suggested solutions allow shaping the caliper body to fully house both the transmission which brings motion to the piston and the gearmotor.

Additionally, but not necessarily, protection is also ensured using a pressure cap with a gasket, fitted after the gearmotors and the entire transmission system are properly positioned. This cap is assembled using a toroidal spring which, by positioning itself in the dedicated seat in the caliper body, ensures the proper positioning without the use of fixing screws. This also results in a reduction of components and thus of costs. In order to avoid the cap from starting to rotate during the operation of the caliper, an anti-rotation system is suggested with the caliper body by means of an appropriately shaped seat, which couples directly to the end part of the electrical cable passage in the cap.

In order to ensure a longer life of the transmission, a sealing gasket is provided in the cap to avoid external bodies (e.g., such as dust) from entering the gearmotor seat, thus decreasing the risk of jamming and excessive wear.

The positioning of the gearmotors inside the caliper body also contributes to having a smaller size of the complete caliper. Indeed, having the gearmotors positioned and oriented in the circumferential zone of the caliper results in a small size, allowing the possibility of using this solution even on wheel sides with small spaces due to limited spaces created in the wheel rim.

### FIGURES

Further features and advantages of the invention will become apparent from the description provided below of preferred exemplary embodiment thereof, given by way of non-limiting indication, with reference to the accompanying drawings, in which:

FIG. 1 shows an axonometric view from the lower (i.e., opposite to the cleaning device) and outer (i.e., wheel side) side of an electro-actuated disc brake caliper according to the invention;

FIG. 2 shows another axonometric view but from the upper and outer side of the caliper body in FIG. 1;

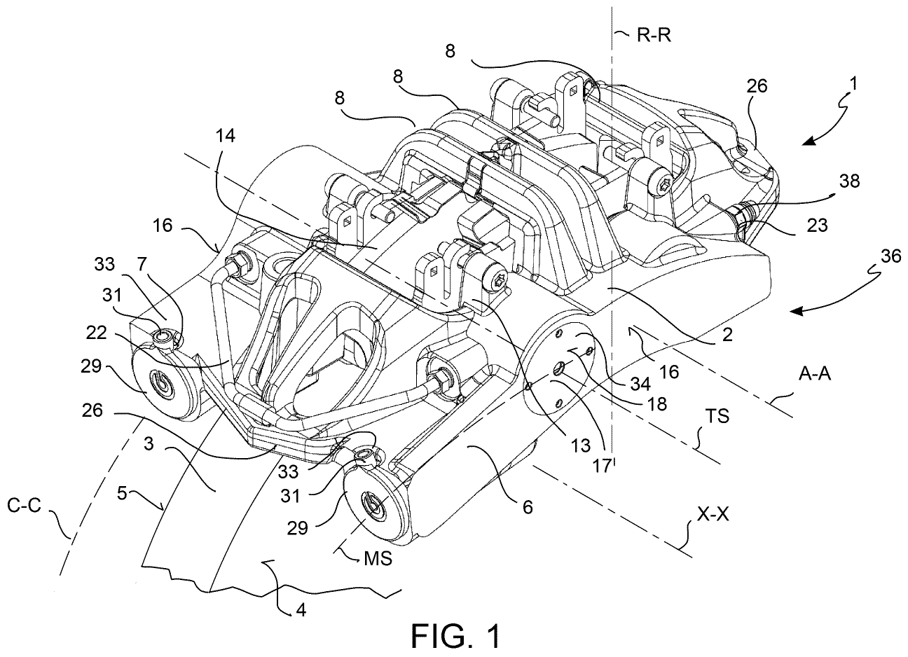

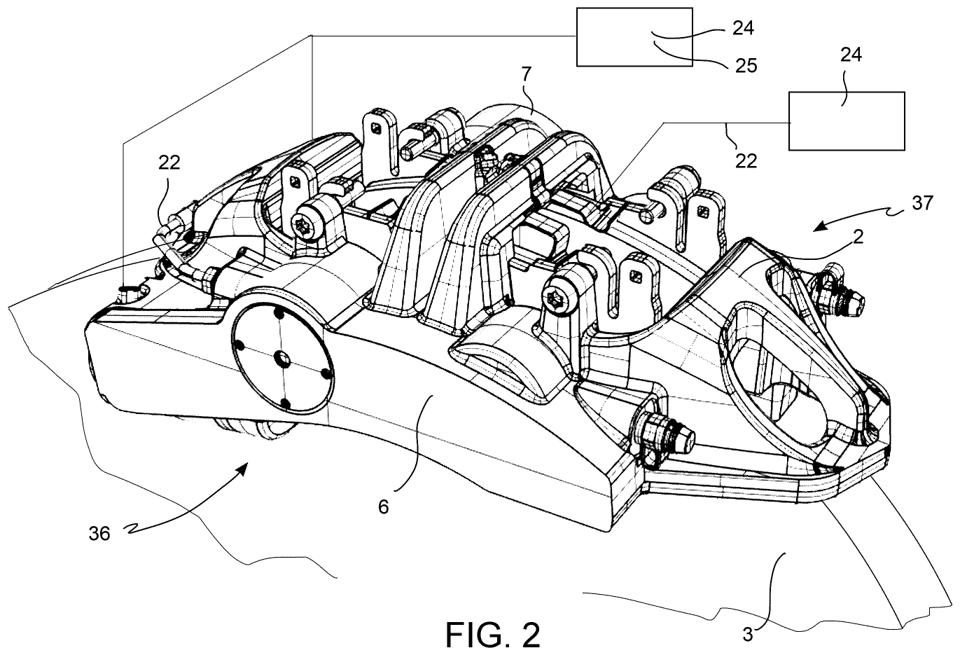

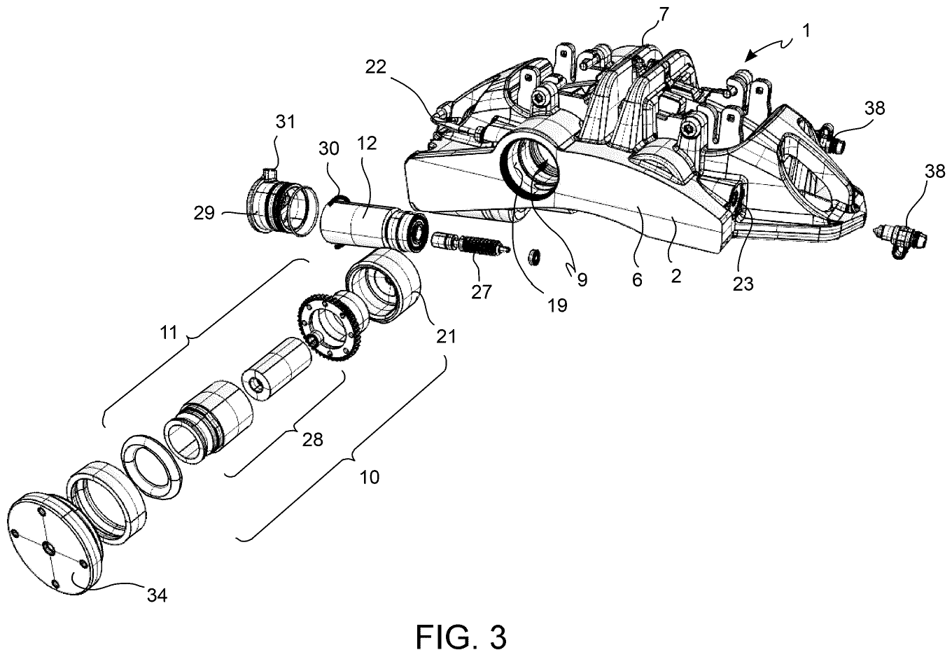

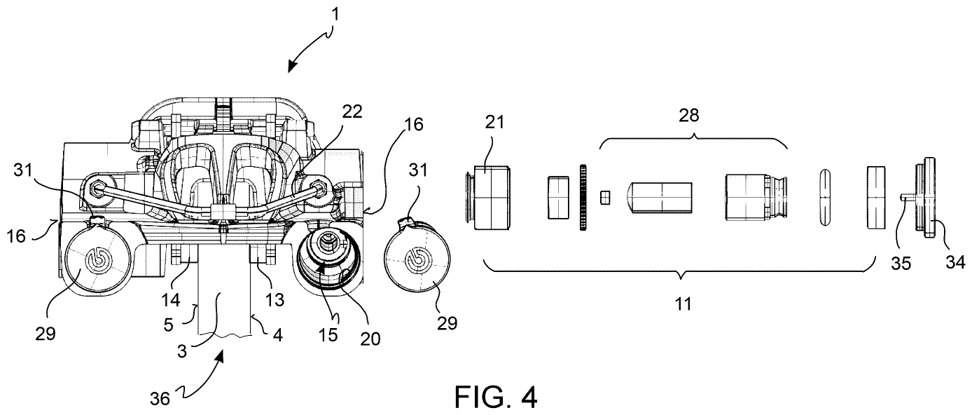

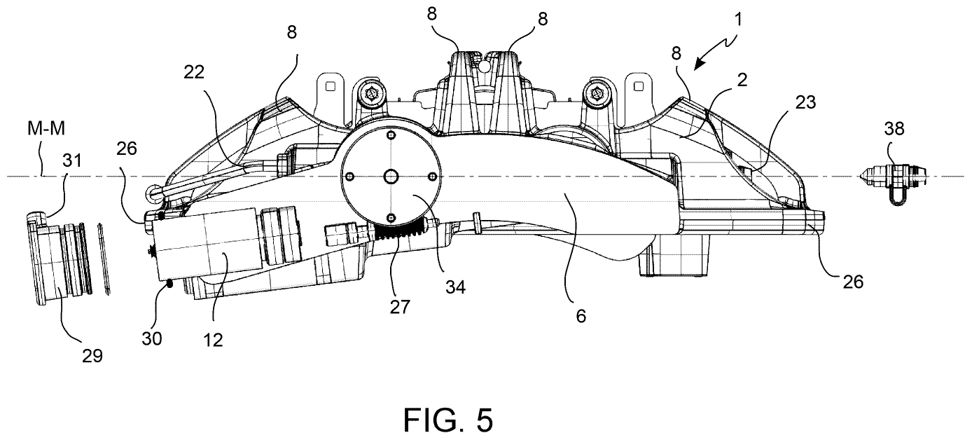

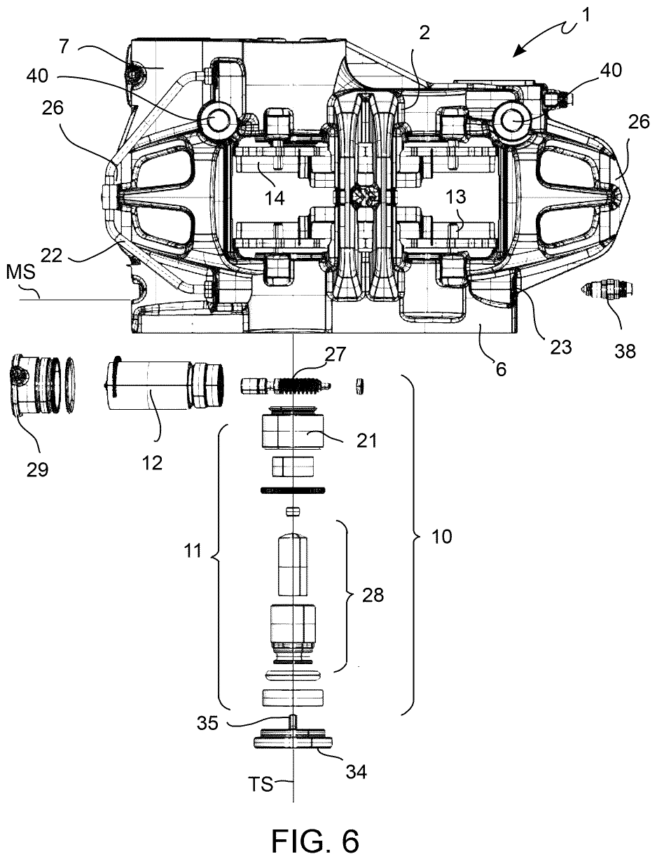

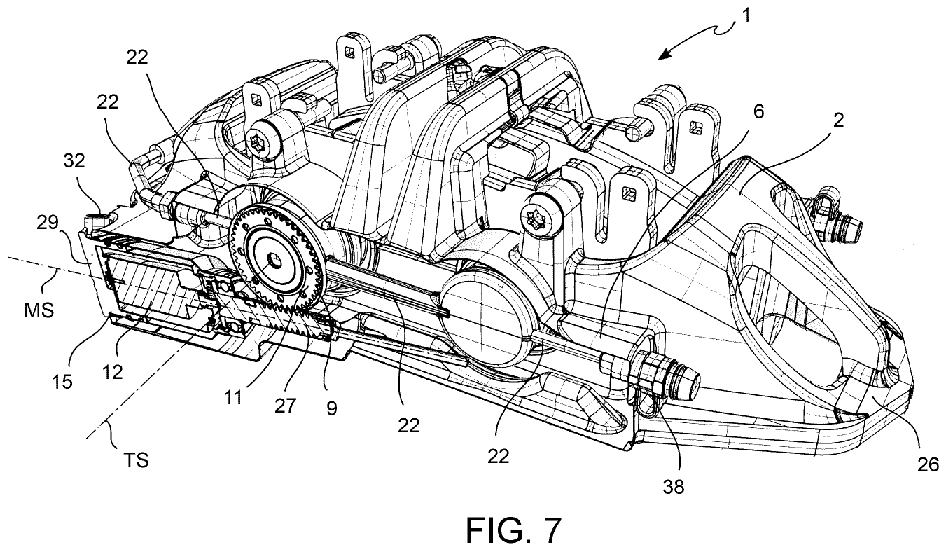

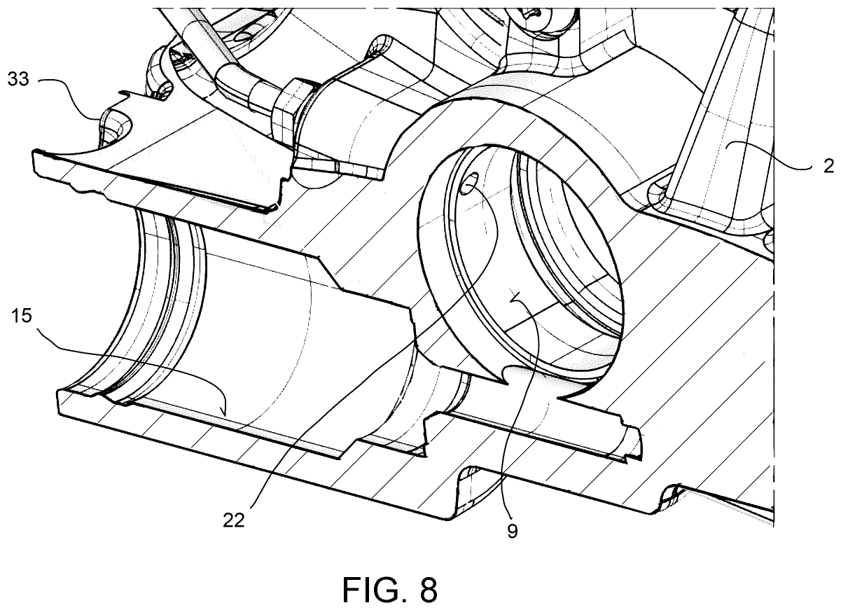

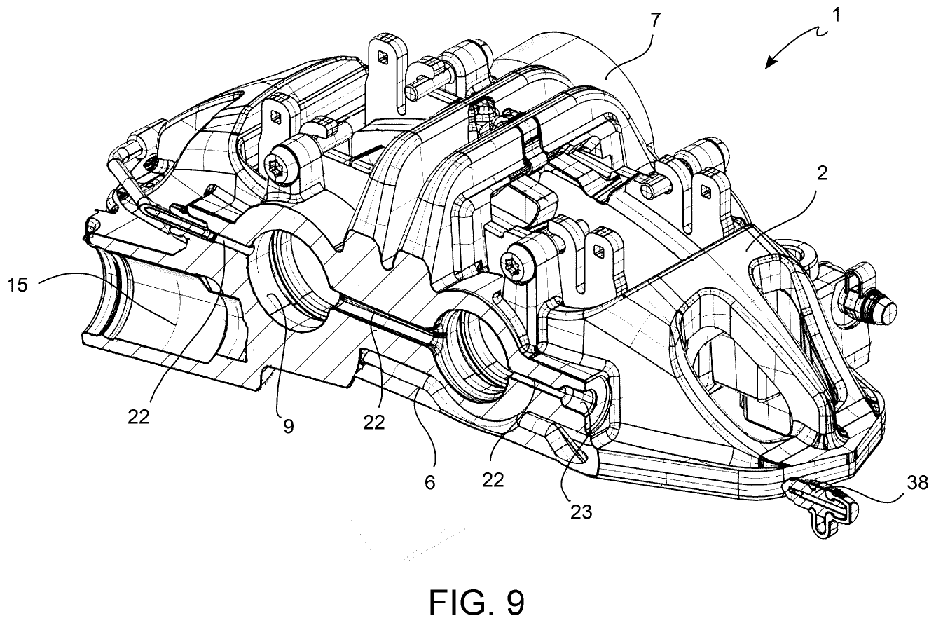

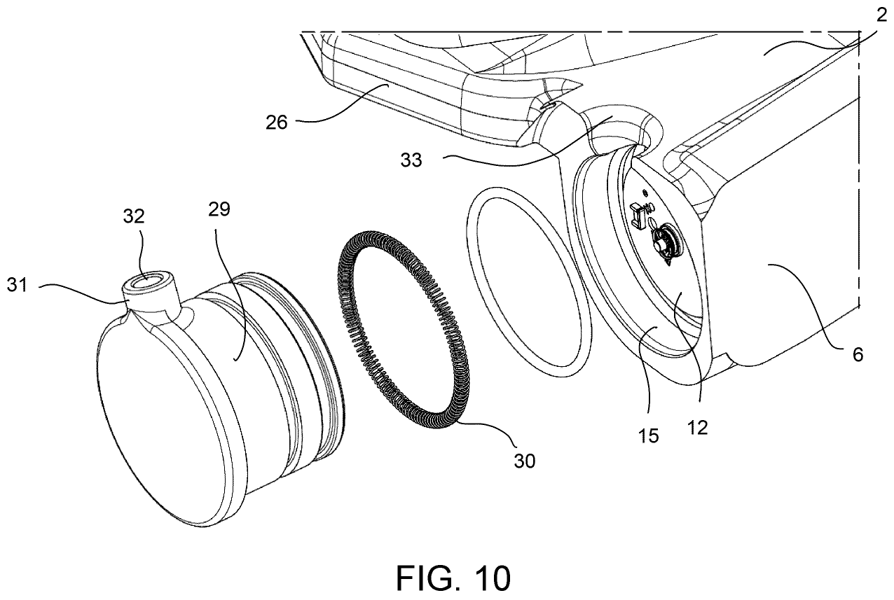

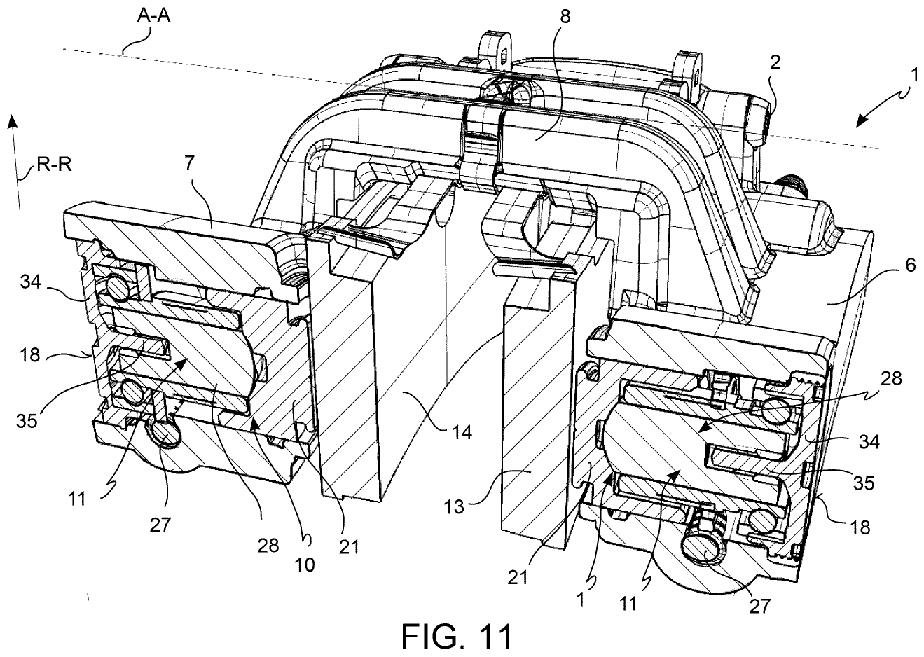

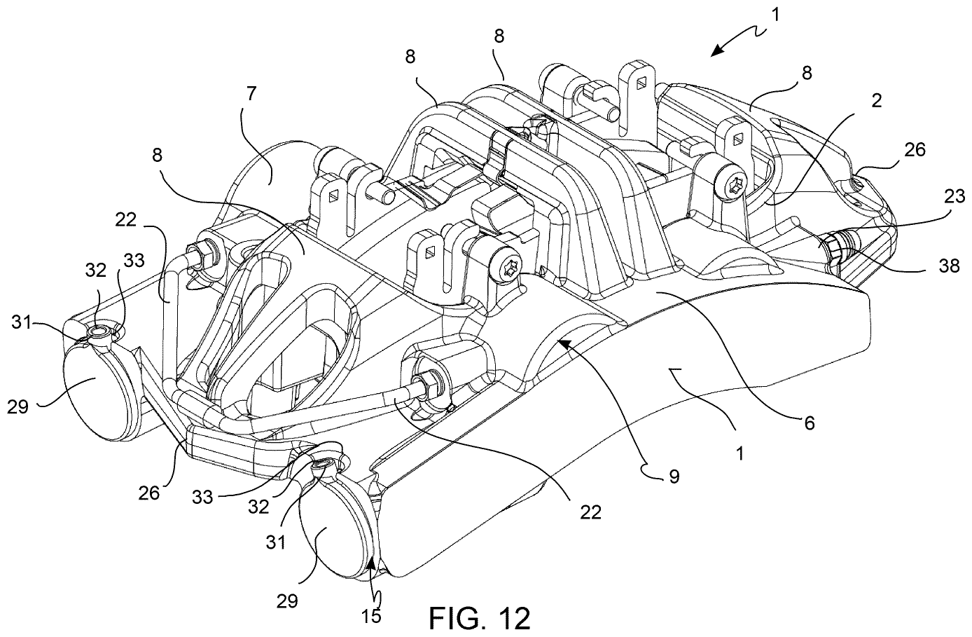

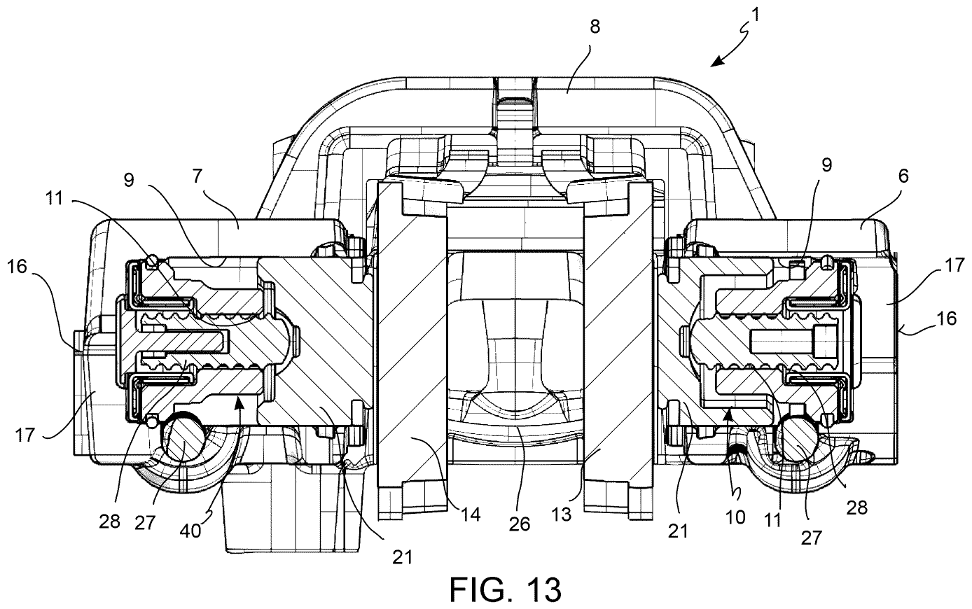

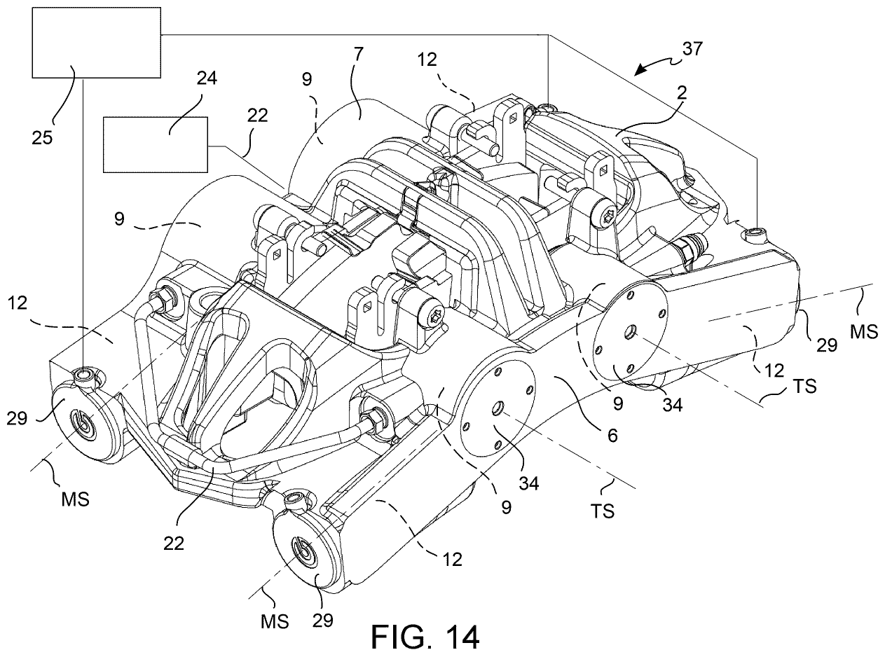

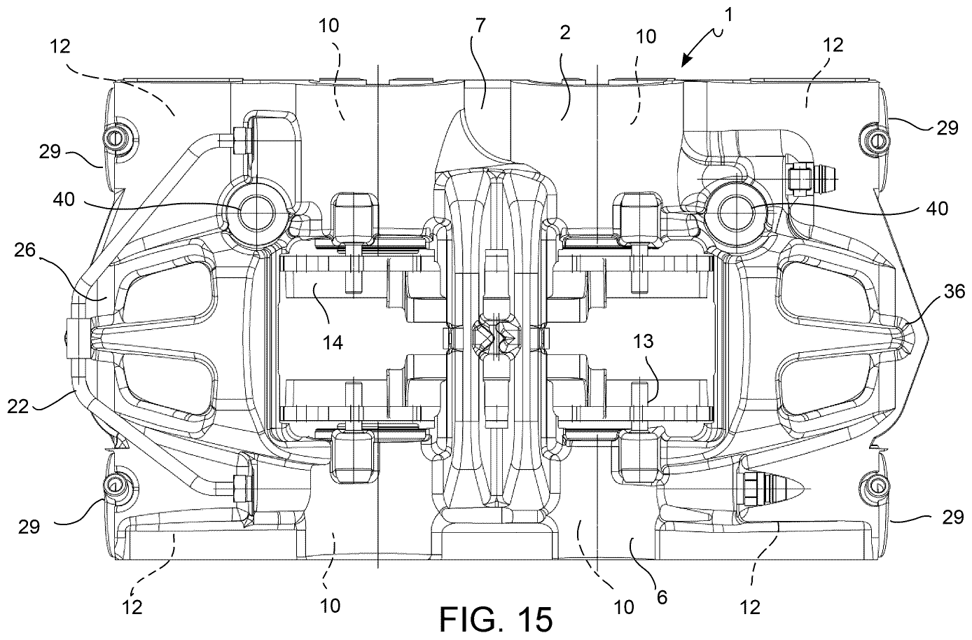

FIGS. from 3 to 6 show an axonometric view, a side view from the motor side, a front view from the wheel side, and an upper view, i.e., from the outer radial direction, respectively, of the caliper in FIG. 1 in which the components of the gearmotor and the thrust means are positioned mutually spaced apart (commonly known as an exploded view) and in which the components of the thrust means are in axis with their assembly direction, while the gearmotor components are in axis with their assembly direction but placed alongside the caliper, i.e., next to their “second motor seat”, so that the meshing between the gearmotor and the mechanical movement device of the thrust means can be inferred, as well as the cleaning device depicted separate and facing the end of the brake fluid adduction circuit;

FIG. 7 shows an axonometric view of the caliper in FIG. 1, taken along a plane, containing the circumferential and radial directions, at the axis of the gearmotor located in the first elongated wheel-side element;

FIG. 8 is an enlargement of FIG. 7 at the second motor seat in which the components of the gearmotor and mechanical movement device have been removed to expose the second motor seat and thrust seat, as well as part of the brake fluid adduction duct;

FIG. 9 is an axonometric view of the caliper in FIG. 1, taken along a plane, containing the circumferential and radial directions, at the axis of the brake fluid adduction duct, in which the components of the gearmotor and mechanical movement device have been removed to expose the second motor seat and the thrust seat, as well as a larger part of the brake fluid adduction duct up to the circuit end connected to a cleaning device, depicted here separated moving away according to the axis of the circuit end;

FIG. 10 is an axonometric view of a detail of the caliper in FIG. 1, close to the end of the second motor seat in which the motor cap, the snap-fixing toroidal spring of the cap, and the cap sealing gasket are depicted in separate parts;

FIG. 11 shows an axonometric view of the caliper in FIG. 1 sectioned according to a plane containing the axial and radial directions passing through the axis of the thrust means;

FIG. 12 shows an axonometric bottom view from the outer side of an electro-actuated disc brake caliper according to a further embodiment;

FIG. 13 shows an axonometric view of the caliper in FIG. 12 taken along a plane containing the axial and radial directions passing through the axis of the thrust means;

FIGS. 14 and 15 show an axonometric view and a radial view, toward the rotation axis of the disc, of an additional embodiment of a caliper, in which four thrust seats are provided, two on each side, and in which all four thrust means are also driven at least by four electric motors, so that each of the thrust means is driven by an independent electric motor and possibly, but not necessarily, by a hydraulic thrust device.

### DESCRIPTION OF SOME PREFERRED EMBODIMENTS

According to a general embodiment, an electro-actuated disc brake caliper 1 comprises a caliper body 2.

Said caliper body 2 is adapted to straddle a brake disc 3 having a rotation axis X-X defining an axial direction A-A, a radial direction R-R orthogonal to said axial direction A-A, and a circumferential direction C-C orthogonal to both said axial A-A and radial R-R directions.

Said brake disc 3 comprises opposite first and second braking surfaces 4, 5.

Said caliper body 2 comprises a first wheel-side elongated element 6 adapted to face said first braking surface 4. In other words, this portion of the caliper body, when the caliper is arranged to straddle the brake disc, is the portion which faces a first braking surface of the brake disc. As can be seen in FIG. 1, for example, this portion, referred to as the first wheel-side elongated element 6, faces the braking surface of the brake disc 3 indicated in the figure by reference numeral 4. In yet other words, this portion of the caliper body differs from a bridge 8 or 26, which are portions projecting to straddle the brake disc 3, because an extension thereof in the axial direction A-A interferes with, i.e., crosses, a lateral surface of the brake disc, i.e., a braking surface, here the surface with reference numeral 4. “Wheel side” means the side in the axial direction A-A which faces the wheel when the caliper is assembled straddling the disc. Such a side is always distinguishable by those skilled in the art because it is the side opposite to the side which allows fixing the caliper body to its support, e.g., as depicted in FIG. 6 and FIG. 15 by means of a fixing seat 40 for housing a screw for fixing the caliper body to its support. In other words, the wheel side of the caliper is that which, in addition to facing the wheel, is cantilevered and connected to the support by means of the bridges of the caliper and the vehicle side of the caliper.

Said caliper body 2 comprises a second vehicle-side elongated element 7 adapted to face said second braking surface 5. In other words, this portion of the caliper body, when the caliper is arranged to straddle the brake disc, is the portion which faces a second braking surface of the brake disc. As can be seen in FIG. 1, for example, this portion, referred to as the second vehicle-side elongated element 7, faces the braking surface of the brake disc 3 indicated in the figure by reference numeral 5. In yet other words, this portion of the caliper body differs from a bridge 8 or 26, which are portions projecting to straddle the brake disc 3, because an extension thereof in the axial direction A-A interferes with, i.e., crosses, a lateral surface of the brake disc, i.e., a braking surface, here the surface with reference numeral 5. The “vehicle side” is always distinguishable by those skilled in the art because it is the side which allows fixing the caliper body to its support, e.g., as depicted in FIG. 6 and FIG. 15 by means of a fixing screw 40 for housing a screw for fixing the caliper body to its support.

Said caliper body 2 comprises at least one connecting bridge, e.g., at least one central bridge 8 and two end bridges 26 joining said first wheel-side elongated element 6 to said second vehicle-side elongated element 7 passing over said brake disc 3.

At least one of said first and second elongated elements 6, 7 comprises at least one thrust seat 9 for accommodating thrust means 10, where said thrust seat 9 comprises a thrust seat extension direction TS substantially parallel to said axial direction A-A.

Thrust means 10 means both a device for applying motion and pressure and a device for transmitting such an action in this axial direction A-A. Therefore, thrust means 10 means an assembly of components.

Said thrust means 10 comprise at least one mechanical movement device 11 adapted to be operated by an electric motor 12 for sliding a thrust device 21 in said thrust seat to abut against a brake pad 13, 14 arranged between said thrust means 10 and said facing braking surface 4, 5 of the brake disc 3.

The thrust device 21 abutting against a brake pad 13, 14 applies the necessary pressure of the brake pad 13, 14 to the braking surface 4, 5 of the brake disc 3 in order to apply the braking action to the vehicle on which the braking system 37 comprising said electro-actuated disc brake caliper 1 is assembled.

Said at least one of said first and second elongated elements 6, 7 comprises at least one additional second motor seat 15.

Said at least one additional second motor seat 15 accommodates at least said electric motor 12.

Said electric motor 12 is operatively connected to said mechanical movement device 11 for the controlled operation of said at least one mechanical movement device 11, in order to activate said thrust means 10 and apply the desired braking action.

According to a possible embodiment and/or disclosure, said at least one additional second motor seat 15 extends along a motor seat direction MS which is transverse to said thrust seat extension direction TS.

According to a possible embodiment and/or disclosure, said at least one of said first and second elongated elements 6, 7 forms said at least one thrust seat 9 and said at least one additional second motor seat 15 in one piece.

According to a possible embodiment and/or disclosure, said at least one of said first and second elongated elements 6, 7 forms said at least one thrust seat 9 so as to avoid said at least one additional second motor seat 15 from being obtained in a body separate from said caliper body and thus removably connected thereto.

According to a possible embodiment and/or disclosure, said at least one additional second motor seat 15 is at least partially radially more internal than said at least one thrust seat 9.

According to a possible embodiment and/or disclosure, said at least one additional second motor seat 15 lies at least partially below the tangential direction M-M passing through the axis of said at least one thrust seat 9.

According to a possible embodiment and/or disclosure, said at least one additional second motor seat 15 lies at least partially below the tangential direction M-M passing through the axis of said at least one thrust seat 9 and the axis of the bleed opening.

According to a possible embodiment and/or disclosure, said motor seat direction MS is arranged in a plane comprising a radial R-R and a circumferential C-C direction.

According to a possible embodiment and/or disclosure, said second motor seat 15 is entirely contained within said at least one of said first and second elongated elements 6, 7.

According to a possible embodiment and/or disclosure, said second motor seat 15 is delimited by motor seat walls 20. Said motor seat walls 20 do not protrude in the axial direction A-A from the remaining part of said at least one of said first and second elongated elements 6, 7.

According to a possible embodiment and/or disclosure, said second motor seat 15 is delimited by motor seat walls 20; and said motor seat walls 20 do not protrude in the circumferential direction C-C from the remaining part of said at least one of said first and second elongated elements 6, 7.

According to a possible embodiment and/or disclosure, said caliper body 4 comprises at least one, preferably two, end bridge(s) 26 adapted to connect the facing ends of said first elongated element 6 to said second elongated element 7.

Said second motor seat 15 is delimited by motor seat walls 20. Said motor seat walls 20 do not protrude in the circumferential direction C-C from the remaining part of said at least one of said first and second elongated elements 6, 7, avoiding protruding circumferentially beyond said at least one end bridge 26, e.g., avoiding protruding cantilevered from said caliper body.

According to a possible embodiment and/or disclosure, said electric motor 12 is entirely contained within said second motor seat 15, avoiding it from protruding cantilevered from said second motor seat 15.

According to a possible embodiment and/or disclosure, said second motor seat 15 is made in a single body, o in one piece, within said at least one of said first and second elongated elements 6, 7.

According to a possible embodiment and/or disclosure, said second motor seat 15 is made in a single body, or in one piece, with said at least one of said first and second elongated elements 6, 7 and with said at least one connecting bridge 8, 26.

According to a possible embodiment and/or disclosure, said at least one of said first and second elongated 6, 7 comprises an outer elongated element surface 16.

Said thrust seat 9 comprises a thrust seat bottom 17 opposite to said brake disc 3 forming an outer bottom surface 18.

The portion of outer elongated element surface 16 placed alongside said second motor seat 15 is substantially planar with said outer bottom surface 18.

According to a possible embodiment and/or disclosure, the outer elongated element surface 16, at least that placed alongside said second motor seat 15, is flat and arranged in a plane containing said circumferential direction C-C and said radial direction R-R.

According to a possible embodiment and/or disclosure, said thrust device comprises at least one hydraulic thrust device 21 for sliding said thrust means 10 in said thrust seat 9 to abut against a brake pad 13, 14 to apply a braking action to said brake disc 3.

Said hydraulic thrust device 21 is fluidly connected to at least one brake fluid adduction duct 22.

According to a possible embodiment and/or disclosure, said at least one brake fluid adduction pipe 22 comprises a circuit end 23.

Said circuit end 23 is placed close to a circumferential end of the caliper body 2.

Said circuit end 23 connected to a cleaning device 38.

Said cleaning device 38 is placed on the opposite side of said second motor seat 15 with respect to said thrust means 10.

According to a possible embodiment and/or disclosure, said at least one hydraulic thrust device 21 is operatively connected to a service braking control device 24 for operating said thrust means 10 during the slowing-down or braking action to stop a vehicle on which said electro-actuated disc brake caliper 1 is assembled.

According to a possible embodiment and/or disclosure, said at least one hydraulic thrust device (21) is operatively connected to a service braking control device (24) for operating said thrust means (10) during the slowing-down or braking action to stop a vehicle on which said electro-actuated disc brake caliper (1) is assembled and said electric motor (12) is operatively connected to a parking braking control device (25) for operating said thrust means (10) during the parking of a vehicle on which said electro-actuated disc brake caliper (1) is assembled, and blocking said hydraulic thrust device (21), and ensuring the vehicle parking.

According to a possible embodiment and/or disclosure, said electric motor 12 is operatively connected to a service braking control device 24 for operating said thrust means 10 during the slowing-down or braking action to stop a vehicle on which said electro-actuated disc brake caliper 1 is assembled.

According to a possible embodiment and/or disclosure, said electric motor 12 is operatively connected to a service braking control device 25 for operating said thrust means 10 during the parking of a vehicle on which said electro-actuated disc brake caliper 1 is assembled.

According to a possible embodiment and/or disclosure, said electric motor 12 is operatively connected to at least two mechanical movement devices 11 placed side by side in the same first or second elongated element 6 or 7. In other words, the same electric motor 12 controls at least two mechanical movement devices 11.

According to a possible embodiment and/or disclosure, said electric motor 12 is a gearmotor.

According to a possible embodiment and/or disclosure, said electric motor 12 is keyed onto a toothed pinion or worm screw of the motor 27.

According to a possible embodiment and/or disclosure, said toothed pinion or said motor worm screw 27 is meshed with said mechanical movement device 11.

According to a possible embodiment and/or disclosure, said mechanical movement device 11 comprise at least one gearmotor.

According to a possible embodiment and/or disclosure, said mechanical movement device 11 comprises a rotary-to-linear motion conversion device 28, for example a worm screw keyed onto a nut screw constrained so as to avoid said nut screw from rotating and being freely translatable, or a worm screw free to translate and keyed onto a nut screw free to rotate and constrained to avoid said nut screw from translating.

According to a possible embodiment and/or disclosure, said mechanical movement device 11 is tightly accommodated in said thrust seat 9.

According to a possible embodiment and/or disclosure, said mechanical movement device 11 is accommodated entirely in said thrust seat 9.

According to a possible embodiment and/or disclosure, said thrust seat 9 accommodates said hydraulic thrust element 21.

Said mechanical movement device 11 biases said hydraulic thrust device 21.

Some brake fluid is adducted by at least one brake fluid adduction duct 22 and biases the same hydraulic thrust device 21 on which said mechanical movement device 11 acts.

According to a possible embodiment and/or disclosure, said second motor seat 15 comprises an opening leading externally from said at least a first or second elongated element 6, 7.

A motor cap 29 closes said opening, closing said second motor seat 15.

According to a possible embodiment and/or disclosure, said second motor seat 15 comprises an opening leading externally from said at least a first or second elongated element 6, 7.

A motor cap 29 closes said opening, closing said second motor seat 15.

Said motor cap 29 is a pressure cap comprising a toroidal spring 30 which connects said motor cap 29 to snap into a niche obtained at the mouth of said second motor seat 15.

According to a possible embodiment and/or disclosure, said second motor seat 15 comprises an opening leading externally from said at least a first or second elongated element 6, 7.

A motor cap 29 closes said opening, sealing off said second motor seat 15 by means of a motor sealing gasket 31.

According to a possible embodiment and/or disclosure, said second motor seat 15 comprises an opening leading externally from said at least a first or second elongated element 6, 7.

A motor cap 29 closes said opening, closing said second motor seat 15.

Said motor cap 29 comprises a protuberance 31 through which there is a passage 32 for a power connection to said electric motor 12.

The walls of said second motor seat 15 comprise a protuberance slot 33 which accommodates said protuberance 31, forming a geometric anti-rotation fit for said motor cap 29.

According to a possible embodiment and/or disclosure, said second motor seat 15 comprises an opening leading externally from said at least a first or second elongated element 6, 7.

A motor cap 29 closes said opening, closing said second motor seat 15.

Said motor cap 29 comprises a protuberance 31 through which there is a passage 32 for a power connection to said electric motor 12.

The walls of said second motor seat 15 comprise 10 protuberance slot 33 which accommodates said protuberance 31, and where said protuberance 31 is entirely embedded in said protuberance slot 33.

According to a possible embodiment and/or disclosure, said thrust seat 9 comprises a thrust seat bottom 17 opposite to said brake disc 3.

Said thrust seat bottom 17 comprises an opening leading externally from said at least a first or second elongated element 6, 7.

A thrust seat cap 29 closes said opening, closing said thrust seat 17.

According to a possible embodiment and/or disclosure, said thrust seat 9 comprises a thrust seat bottom 17 opposite to said brake disc 3.

Said thrust seat bottom 17 comprises an opening leading externally from said at least a first or second elongated element 6, 7.

A thrust seat cap 29 closes said opening, sealing off said thrust seat 17.

According to a possible embodiment and/or disclosure, said thrust seat 9 comprises a thrust seat bottom 17 opposite to said brake disc 3.

Said thrust seat bottom 17 comprises an opening leading externally from said at least a first or second elongated element 6, 7.

A thrust seat cap 29 closes said opening, closing said thrust seat 17 by screwing on the threaded walls of said opening.

According to a possible embodiment and/or disclosure, said thrust seat 9 comprises a thrust seat bottom 17 opposite to said brake disc 3.

Said thrust seat bottom 17 comprises an opening leading externally from said at least a first or second elongated element 6, 7.

A thrust seat cap 29 closes said opening, closing said thrust seat 17.

Said thrust seat cap 29 comprises a cap extension 35 which projects inside said thrust seat 9 and supports, or freely rotationally supports, at least one part of said mechanical movement device 11.

According to a possible embodiment and/or disclosure, said electro-actuated disc brake caliper 1 is a fixed-type caliper.

According to a possible embodiment and/or disclosure, said electro-actuated disc brake 1 is a fixed-type caliper, and said caliper 2 is in one piece.

According to a possible embodiment and/or disclosure, both said first and said second elongated elements 6, 7 comprise at least one thrust seat 9 for accommodating thrust means 10, where said thrust seat 9 comprises a thrust seat extension direction TS substantially parallel to said axial direction A-A.

Both said first and said second elongated elements 6, 7 comprise at least one additional second motor seat 15.

Each second motor seat 15 comprises an electric motor 12.

According to a possible embodiment and/or disclosure, both said first and said second elongated elements 6, 7 each comprise two thrust seats 9 for accommodating thrust means 10, where said thrust seats 9 each comprise a thrust seat extension direction TS substantially parallel to said axial direction A-A.

Both said first and said second elongated elements 6, 7 each comprise two second motor seats 15.

Each second motor seat 15 comprises an electric motor 12.

The present invention also relates to a brake disc 36 comprising an electro-actuated disc brake caliper 1 according to any one of the preceding embodiments.

The present invention also relates to a braking system 37 comprising a disc brake 36 as described above, as well as at least one service braking control device 24 and at least one parking braking control device 25.

### LIST OF REFERENCE SIGNS

1 electro-actuated disc brake caliper
2 caliper body
3 brake disc
4 first wheel-side braking surface
5 second vehicle-side braking surface
6 first wheel-side elongated element
7 second vehicle-side elongated element
8 at least one connecting bridge
9 thrust seat
10 thrust means
11 mechanical movement device
12 electric motor
13 brake pad
14 brake pad
15 second motor seat
16 outer elongated element surface
17 thrust seat bottom
18 outer bottom surface
19 thrust seat walls
20 motor seat walls
21 thrust device or hydraulic thrust device
22 at least one brake fluid adduction duct
23 circuit end
24 service braking control device
25 parking braking control device
26 end bridge
27 motor worm screw
28 rotary-to-linear motion conversion device
29 motor cap
30 toroidal spring
31 motor cap protuberance
32 protuberance passage
33 protuberance slot
34 thrust seat cap
35 cap extension
36 disc brake
37 braking system
38 cleaning device
40 seat for fixing the caliper to the support, e.g., the stub axle of the vehicle
X-X brake disc rotation axis
A-A axial direction
R-R radial direction
C-C circumferential direction
TS thrust seat extension direction
MS motor seat direction
M-M tangential direction passing through the axis of said at least one thrust seat

1-20. (canceled)

21. An electro-actuated disc brake caliper, wherein
said electro-actuated disc brake caliper comprises a caliper body;
said caliper body is adapted to straddle a brake disc having a rotation axis defining an axial direction, a radial direction orthogonal to said axial direction, and a circumferential direction orthogonal to both said axial and radial directions, wherein said brake disc comprises a first braking surface and an opposite second braking surface;
said caliper body comprises a first elongated element adapted to face said first braking surface;
said caliper body comprises a second elongated element adapted to face said second braking surface;
said caliper body comprises at least one connecting bridge joining said first elongated element to said second elongated element passing over said brake disc;
at least one of said first and second elongated elements comprises at least one thrust seat for accommodating thrust means, said at least one thrust seat having a thrust seat extension direction substantially parallel to said axial direction;
wherein said thrust means comprise at least one mechanical movement device adapted to be operated by an electric motor for sliding a thrust device in said at least one thrust seat to abut against a brake pad arranged between said thrust means and said first and second braking surfaces of the brake disc;
wherein said at least one of said first and second elongated elements comprises at least one additional second motor seat;
wherein said at least one additional second motor seat accommodates at least said electric motor;
wherein said electric motor is operatively connected to said at least one mechanical movement device for a controlled operation of said at least one mechanical movement device; and
wherein said at least one additional second motor seat extends along a motor seat direction transverse to said thrust seat extension direction.

22. The electro-actuated disc brake caliper of claim 21, wherein the electro-actuated disc brake caliper comprises at least one of the following features or a combination thereof:
said at least one of said first and second elongated elements forms said at least one thrust seat and said at least one additional second motor seat in one piece;
said at least one of said first and second elongated elements forms said at least one thrust seat and said at least one additional second motor seat in one piece, preventing said at least one additional second motor seat from being obtained in a body separate from said caliper body and thus removably connected thereto;
said at least one additional second motor seat is at least partially radially more internal than said at least one thrust seat;
said at least one additional second motor seat is at least partially radially more internal than said at least one thrust seat and lies at least partially below a tangential direction passing through an axis of said at least one thrust seat;
said motor seat direction is arranged in a plane comprising the radial and circumferential directions;
said at least one of said first and second elongated elements forms said at least one thrust seat and said at least one additional second motor seat in one piece;
said at least one of said first and second elongated elements forms said at least one thrust seat so as to avoid said at least one additional second motor seat from being obtained in a body separate from said caliper body and thus removably connected thereto;
said at least one additional second motor seat is at least partially radially more internal than said at least one thrust seat;
said at least one additional second motor seat lies at least partially below the tangential direction passing through the axis of said at least one thrust seat.

23. The electro-actuated disc brake caliper of claim 21, wherein
said at least one additional second motor seat is entirely contained within said at least one of said first and second elongated elements;
or
said at least one additional second motor seat is delimited by motor seat walls, and wherein said motor seat walls do not protrude in the axial direction from a remaining part of said at least one of said first and second elongated elements;
and/or wherein
said at least one additional second motor seat is delimited by motor seat walls, and wherein said motor seat walls do not protrude in the circumferential direction from the remaining part of said at least one of said first and second elongated elements;
and/or wherein
said caliper body comprises at least one, preferably two, end bridge(s) adapted to connect facing ends of said first elongated element to said second elongated element, and
said at least one additional second motor seat is delimited by motor seat walls, wherein said motor seat walls do not protrude in the circumferential direction from the remaining part of said at least one of said first and second elongated elements, avoiding circumferentially protruding beyond said at least one end bridge.

24. The electro-actuated disc brake caliper of claim 21, wherein said electric motor is entirely contained within said at least one additional second motor seat.

25. The electro-actuated disc brake caliper of claim 21, wherein
said at least one additional second motor seat is made in a single body, or in one piece, with said at least one of said first and second elongated elements;
or wherein
said at least one additional second motor seat is made in a single body, or in one piece, with said at least one of said first and second elongated elements and with said at least one connecting bridge.

26. The electro-actuated disc brake caliper of claim 21, wherein
said at least one of said first and second elongated elements comprises an outer elongated element surface; wherein
said at least one thrust seat comprises a thrust seat bottom opposite to said brake disc forming an outer bottom surface; and wherein
a portion of the outer elongated element surface placed alongside said at least one additional second motor seat is substantially planar with said outer bottom surface.

27. The electro-actuated disc brake caliper of claim 21, wherein
said thrust device comprises at least one hydraulic thrust device for sliding said thrust means in said at least one thrust seat to abut against the brake pad to apply a braking action to said brake disc; and wherein
said at least one hydraulic thrust device is fluidly connected to at least one brake fluid adduction duct.

28. The electro-actuated disc brake caliper of claim 27, wherein
said at least one brake fluid adduction duct comprises a circuit end;
said circuit end is placed close to a circumferential end of the caliper body;
said circuit end is connected to a cleaning device; and wherein
said cleaning device is placed on an opposite side of said at least one additional second motor seat with respect to said thrust means.

29. The electro-actuated disc brake caliper of claim 27, wherein
said at least one hydraulic thrust device is operatively connected to a service braking control device for operating said thrust means during slowing-down or during a braking action to stop a vehicle on which said electro-actuated disc brake caliper is assembled;
or wherein
said at least one hydraulic thrust device is operatively connected to a service braking control device for operating said thrust means during slowing-down or during a braking action to stop a vehicle on which said electro-actuated disc brake caliper is assembled, and wherein
said electric motor is operatively connected to a parking braking control device for operating said thrust means during parking of the vehicle on which said electro-actuated disc brake caliper is assembled, and blocking said at least one hydraulic thrust device, and ensuring the parking of the vehicle.

30. The electro-actuated disc brake caliper of claim 21, wherein
said electric motor is operatively connected to a service braking control device for operating said thrust means during slowing-down or during a braking action to stop a vehicle on which said electro-actuated disc brake caliper is assembled;
and/or wherein
said electric motor is operatively connected to a parking braking control device for operating said thrust means during parking of the vehicle on which said electro-actuated disc brake caliper is assembled.

31. The electro-actuated disc brake caliper of claim 21, wherein said electric motor is operatively connected to at least two mechanical movement devices placed side by side in the first or second elongated element.

32. The electro-actuated disc brake caliper of claim 21, wherein said electric motor is a gearmotor;
and/or wherein
said electric motor is keyed onto a toothed pinion or a motor worm screw, and wherein
said toothed pinion or said motor worm screw is meshed with said at least one mechanical movement device.

33. The electro-actuated disc brake caliper of claim 21, wherein said at least one mechanical movement device comprises at least one gear unit;
and/or wherein
said at least one mechanical movement device comprises a rotary-to-linear motion conversion device, optionally the rotary-to-linear motion conversion device being a worm screw keyed onto a nut screw constrained so as to prevent said nut screw from rotating and being freely translatable, or a worm screw free to translate and keyed onto a nut screw free to rotate and constrained to prevent said nut screw from translating.

34. The electro-actuated disc brake caliper of claim 21, wherein said at least one mechanical movement device is tightly accommodated in said at least one thrust seat.

35. The electro-actuated disc brake caliper of claim 27, wherein
said at least one thrust seat accommodates said at least one hydraulic thrust device, wherein
said at least one mechanical movement device biases said at least one hydraulic thrust device, and wherein
brake fluid is adducted by at least one brake fluid adduction duct and biases the at least one hydraulic thrust device.

36. The electro-actuated disc brake caliper of claim 21, wherein the electro-actuated disc brake caliper comprises at least one of the following features or a combination thereof:
said at least one additional second motor seat comprises an opening leading externally from said at least first or second elongated element, and wherein
a motor cap closes said opening, closing said at least one additional second motor seat;
said at least one additional second motor seat comprises an opening leading externally from said at least first or second elongated element, wherein
a motor cap closes said opening, closing said at least one additional second motor seat, and wherein
said motor cap is a pressure cap comprising a toroidal spring that connects said motor cap to snap into a niche formed at a mouth of said at least one additional second motor seat;
said at least one additional second motor seat comprises an opening leading externally from said at least first or second elongated element, and wherein
a motor cap closes said opening, sealing off said at least one additional second motor seat by a motor sealing gasket;
said at least one additional second motor seat comprises an opening leading externally from said at least first or second elongated element, wherein
a motor cap closes said opening, closing said at least one additional second motor seat, wherein
said motor cap comprises a protuberance through which there is a passage for a power connection to said electric motor, and wherein
the motor seat walls of said at least one additional second motor seat comprise a protuberance slot that accommodates said protuberance, forming a geometric anti-rotation fit for said motor cap;
said at least one additional second motor seat comprises an opening leading externally from said at least first or second elongated element, wherein
a motor cap closes said opening, closing said at least one additional second motor seat, wherein
said motor cap comprises a protuberance through which there is a passage for a power connection to said electric motor, wherein
the motor seat walls of said at least one additional second motor seat comprise a protuberance slot that accommodates said protuberance, and wherein said protuberance is entirely embedded in said protuberance slot.

37. The electro-actuated disc brake caliper of claim 21, wherein the electro-actuated disc brake caliper comprises at least one of the following features or a combination thereof:
said at least one thrust seat comprises a thrust seat bottom opposite to said brake disc, wherein
said thrust seat bottom comprises an opening leading externally from said at least first or second elongated element, and wherein
a thrust seat cap closes said opening, closing said thrust seat;
said at least one thrust seat comprises a thrust seat bottom opposite to said brake disc, wherein
said thrust seat bottom comprises an opening leading externally from said at least first or second elongated element, and wherein
a thrust seat cap closes said opening, sealing off said thrust seat;
said at least one thrust seat comprises a thrust seat bottom opposite to said brake disc, wherein
said thrust seat bottom comprises an opening leading externally from said at least first or second elongated element, and wherein
a thrust seat cap closes said opening, closing said thrust seat by screwing on threaded walls of said opening;
said at least one thrust seat comprises a thrust seat bottom opposite to said brake disc, wherein
said thrust seat bottom comprises an opening leading externally from said at least first or second elongated element, and wherein
a thrust seat cap closes said opening, closing said thrust seat;
said thrust seat cap comprises a cap extension projecting inside said at least one thrust seat and supports, or freely rotationally supports, at least one part of said at least one mechanical movement device.

38. The electro-actuated disc brake caliper of claim 21, wherein
said electro-actuated disc brake caliper is a fixed-type caliper;
or wherein
said electro-actuated disc brake caliper is a fixed-type caliper and said caliper body is in one piece;
or wherein
both said first and second elongated elements comprise at least one thrust seat for accommodating the thrust means, wherein said at least one thrust seat has a thrust seat extension direction substantially parallel to said axial direction, wherein
both said first and second elongated elements comprise at least one additional second motor seat, and wherein
each additional second motor seat comprises an electric motor;
and/or wherein
both said first and second elongated elements comprise two thrust seats for accommodating the thrust means, wherein said thrust seats each have a thrust seat extension direction substantially parallel to said axial direction, wherein
both said first and second elongated elements comprise two additional second motor seats, and wherein
each additional second motor seat comprises an electric motor.

39. A disc brake comprising the electro-actuated disc brake caliper of claim 21.

40. A braking system comprising the disc brake of claim 39, and at least one service braking control device and at least one parking braking control device.
